(19) United States
(12) Patent Application Publication
(10) Pub. No.: US 2018/0319317 A1
(43) Pub. Date: Nov. 8, 2018

(54) CONTROL DEVICE FOR A LIGHTING UNIT IN A MOTOR VEHICLE, AND METHOD FOR CONTROLLING A LIGHTING UNIT OF SAID TYPE

(71) Applicant: ZKW Group GmbH, Wieselburg (AT)

(72) Inventors: Josef PLANK, Purgstall/Erlauf (AT); Lukas TAUDT, Wieselburg (AT)

(21) Appl. No.: 15/740,637

(22) PCT Filed: Jun. 16, 2016
(86) PCT No.: PCT/AT2016/050209

§ 371 Date: Jan. 25, 2018

(30) Foreign Application Priority Data
Jun. 29, 2015 (AT) A50558/2015

(51) Int. Cl. B60Q 1/14; B60Q 1/08; G06K 9/00

(52) U.S. Cl. CPC B60Q 1/143; B60Q 1/085; B60Q 2300/112; B60Q 2300/056; B60Q 2300/41; G06K 9/00825

(57) ABSTRACT

The invention relates to a controller (7) for controlling at least one lighting device (3, 5) for a motor vehicle (10), this at least one lighting device (3, 5) being able to produce a defined low beam pattern (ABV1, ABV2). If an optical image recognition system (6) detects a vehicle driving in front, then the controller controls the lighting device so that the passengers of the vehicle driving in front, in particular the driver, are not blinded through a side view mirror.

The invention relates to a controller for controlling at least one motor vehicle lighting device or for controlling a motor vehicle headlight that has at least one such lighting device, this at least one lighting device being set up at least to produce at least one defined dimmed light pattern, in particular at least one defined low beam pattern, in an area in front of the lighting device, in particular in an area in front of the motor vehicle.

Furthermore, the invention relates to a motor vehicle lighting device this at least one lighting device being set up at least to produce at least one defined dimmed light pattern, in particular at least one defined low beam pattern, in an area in front of the lighting device, in particular in an area in front of the motor vehicle.

The invention also relates to a motor vehicle headlight that comprises at least one such a lighting device.

In addition, the invention relates to a motor vehicle lighting device system that comprises two motor vehicle headlights, a left and a right motor vehicle headlight and that is provided for a motor vehicle for driving on the right/left.

Moreover, the invention also relates to a motor vehicle with at least one, in particular two such motor vehicle headlights or with a lighting device system described above.

Finally, the invention also relates to a process for controlling at least one above-described lighting device or a lighting device system mentioned above.

Today motor vehicle headlights, for example car headlights, use intelligent systems that selectively modify light patterns in low beam and high beam operation to achieve optimal visibility in the dark, without this blinding other road users.

In particular, at the present time the following systems are used:

1) In low beam operation or dimmed light operation, it is possible to activate or switch between one of the following light patterns, for example, depending on the situation:
Country road light;
Superhighway light;
City light;
Bad weather light;

Depending on various factors (vehicle speed, steering angle, moisture on the road or windshield wiper operation, recognized street lighting, GPS input, etc.), one of these four light functions is activated, each of which produces a different dimmed light pattern. For example, city light can be activated if the maximum vehicle speed is 60 km/h or if (the vehicle automatically) detects street lighting.

These light functions are known as an AFS (Adaptive Front Lighting System). These dimmed light functions do not take into consideration any camera information.

2) High beams: If all legally prescribed conditions for high beams are met (outside of a town, insufficient ambient light, no oncoming vehicles or vehicles driving in front), then high beams can be activated. In addition to manual activation by the driver, it is also possible for high beams to be activated in an automated manner using an optical image recognition system, e.g., through a camera or a camera system.

An enhancement of the classic high beams is the so-called ADB (Adaptive Driving Beam) system. This involves recognizing vehicles driving in front and oncoming vehicles through an optical image recognition system. Special lighting devices for motor vehicles, in particular motor vehicle headlights, are able to produce a high beam pattern in which the area of the vehicles driving in front and oncoming vehicles is selectively masked. Thus, if the conditions
outside of a town; and
insufficient ambient light

to provide high beams in front of the motor vehicle, without blinding other drivers, by illuminating only those areas in which there are no other vehicles. This can clearly increase traffic safety on open country roads.

For certain dimmed light patterns, in particular for the country road and superhighway light patterns, the law prescribes an asymmetric light pattern which should still selectively illuminate the right edge of the road, in the case of driving on the right. In the case of driving on the left, the law correspondingly provides that the left edge of the road should still be illuminated.

Such dimmed light patterns which still illuminate the respective driver's own edge of the road are referred to as low beam patterns, and the corresponding light function is referred to as low beam function.

However, such low beam patterns can nevertheless present the problem of mirror blinding of a vehicle driving in front. The asymmetric design of the low beam pattern can blind the driver of a vehicle driving in front through the side view mirror, namely (mostly) through the right side view mirror in the case of driving on the right, and through the left side view mirror in the case of driving on the left.

In the asymmetric area of the low beam pattern its light/dark boundary rises, as is known, at a certain angle, e.g., 45° to the horizontal (when viewed, in a way known in the art, on a vertical plotting screen at a defined distance, e.g., 25 meters, from the lighting device).

In particular, the described problem also occurs in lighting devices that construct a light pattern, in particular a low beam pattern, from individual light segments, e.g., light segments lying next to one another or next to one another and on top of one another. These light segments are, for example, vertical, in particular approximately rectangular or square.

In such lighting devices it is frequently, or as a rule provided that the asymmetry in the low beam pattern, i.e., the asymmetric section of the light/dark boundary, rises at an angle of 90°.

When such lighting devices are used, the described problem is especially important, and in certain driving situations the situation can arise that taking camera data into consideration would make the blinding in (high beam) ADB operation even less than it would be with the low beam pattern that is legally prescribed in the current driving situation (e.g., country road light).

It is a goal of the invention to indicate a solution for the above-described problem.

This is accomplished with a controller mentioned at the beginning by the fact that according to the invention the at least one lighting device is set up so that at least one defined dimmed light pattern, in particular at least one defined low beam pattern
is modified, at least with respect to its position and/or shape, when a dimmed light pattern or low beam pattern is turned on, and/or
the dimmed light pattern or low beam pattern whose position and/or shape has been modified is turned on,

the controller using information that comes from at least one object detection system, e.g., an optical image recognition system,

the at least one object detection system monitoring the area lying in front of the lighting device or the motor vehicle, in particular at least the area illuminated by the at least one dimmed light pattern, in particular by the at least one low beam pattern,

to control the at least one lighting device so that a lighting device or a motor vehicle for driving on the right/left does not illuminate the right/left side view mirror of a motor vehicle driving in front when the dimmed light pattern is activated, in particular when the low beam pattern is activated, and/or when the dimmed light pattern is turned on, in particular when the low beam pattern is turned on.

The goal of the invention is further accomplished with a lighting device mentioned at the beginning, the lighting device being associated, according to the invention, with an inventive controller or the lighting device comprising such an inventive controller, and the at least one lighting device being set up so that at least one defined dimmed light pattern, in particular at least one defined low beam pattern
is modified, at least with respect to its position and/or shape, when a dimmed light pattern or low beam pattern is turned on, and/or
the dimmed light pattern or low beam pattern whose position and/or shape has been modified is turned on,

the lighting device comprising at least one object detection system or the lighting device being associated with at least one object detection system,

the controller being set up to use information that comes from at least one object detection system,

the at least one object detection system monitoring the area lying in front of the lighting device or the motor vehicle, in particular at least the area illuminated by the at least one dimmed light pattern, in particular by the at least one low beam pattern,

to control the at least one lighting device so that a lighting device or a motor vehicle for driving on the right/left does not illuminate the right/left side view mirror of a motor vehicle driving in front when a dimmed light pattern is activated, in particular a low beam pattern is activated, and/or when the dimmed light pattern is turned on, in particular when the low beam pattern is turned on.

Moreover, this goal is also accomplished with an above-described lighting device system that comprises at least one inventive lighting device, this at least one lighting device being a left/right motor vehicle headlight or part of a left/right motor vehicle headlight, and

the two motor vehicle headlights being set up so that together they produce at least one dimmed light pattern, in particular at least one low beam pattern,

and the lighting device system comprising at least one inventive controller or the lighting device system being associated with at least one inventive controller,

the lighting device system comprising at least one object detection system or the lighting device system being associated with at least one object detection system,

the controller being set up, to use information that comes from the at least one object detection system,

the at least one object detection system monitoring the area lying in front of the lighting device or the motor vehicle, in particular at least the area illuminated by the at least one dimmed light pattern, in particular by the at least one low beam pattern,

to control the at least one lighting device so that a lighting device system for driving on the right/left does not illuminate the right/left side view mirror of a motor vehicle driving in front when a dimmed light pattern is activated, in particular when a low beam pattern is activated, and/or when the dimmed light pattern is turned on, in particular when the low beam pattern is turned on.

Finally, the goal of the invention is also accomplished with a process mentioned at the beginning that is characterized by the following steps:
monitoring an area lying in front of the lighting device or the motor vehicle, in particular at least the area illuminated by the at least one dimmed light pattern, in particular by the at least one low beam pattern, using at least one object detection system;
controlling, by at least one controller, the at least one lighting device or the lighting device system using information that comes from the at least one object detection system;

in such a way that

a defined dimmed light pattern, in particular at least one defined low beam pattern
is modified, at least with respect to its position and/or shape, when a dimmed light pattern is turned on or when a low beam pattern is turned on, and/or
the dimmed light pattern or low beam pattern whose position and/or shape has been modified is turned on,

so that a lighting device or a motor vehicle for driving on the right/left does not illuminate the right/left side view mirror of a motor vehicle driving in front when a dimmed light pattern is activated, in particular when a low beam pattern is activated, and/or when the dimmed light pattern is turned on, in particular when the low beam pattern is turned on.

According to the invention, the area or the surroundings in front of a motor vehicle is observed by an object detection system, e.g., an optical image recognition system, in particular a camera or a camera system.

Such an object detection system is set up to detect at least one vehicle, in particular a passenger vehicle, driving in front of the vehicle in which the object detection system is put. Preferably, it is also possible to determine the position and/or distance of the vehicle driving in front with respect to the object detection system. On the basis of this information, it is already possible to carry out the inventive control.

Preferably such a object detection system is also set up to determine details or certain structures of the vehicle driving in front, in particular one or both side view mirrors, or preferably also their position with respect to the object detection system.

As a rule, such an object detection system can be, e.g., one or more cameras, as has already been explained above. However, the object detection system can also comprise one or more corresponding sensors, e.g., distance sensors, which can determine the necessary information.

However, the object detection system can also consist of car-to-car communication, through which the vehicles communicate their position, or the object detection system can also consist of a communications system with a central entity that has information about vehicle positions and makes this available to other vehicles.

According to the invention, the information determined using the object detection system is now also used in dimmed light operation, namely in the case that turning on a dimmed light pattern, in particular a low beam pattern, or in the case that an already activated dimmed light pattern, in particular a low beam pattern, would illuminate a vehicle driving in front in such a way that its driver would be blinded, or could be blinded through a side view mirror, this information is used to turn on the dimmed light pattern, in particular the low beam pattern in a modified way, or to modify the activated dimmed light pattern, in particular the low beam pattern so that such blinding can be avoided.

Within the limits of legal requirements, a dimmed light pattern, in particular a low beam pattern is inventively modified so that the driver of the vehicle driving in front is not blinded through its side view mirrors.

This defined dimmed light pattern or low beam pattern corresponds to a conventional (low beam) light pattern known from the prior art and typically used in known vehicles.

The inventively modified dimmed light patterns or modified low beam patterns differ from the defined light pattern, which can also be referred to as a basic dimmed light pattern and basic low beam pattern.

If the modified dimmed light patterns or the modified low beam patterns are discussed in the plural here, it should be noted that according to the invention it is also always only possible to provide exactly one modified light pattern corresponding to a defined light pattern. This modified light pattern is then preferably modified with respect to the defined light pattern strongly enough that blinding of the vehicle driving in front or its driver or passengers can be avoided, or at least reduced for multiple possible traffic situations.

However, it is preferably provided that the defined light pattern is modified exactly enough that exactly no blinding occurs, or that the blinding is sufficiently reduced, depending on the situation that is determined using the at least one optical image recognition system. Thus, there are multiple different modified light patterns, depending on the situation in front of the motor vehicle.

Thus, the invention proposes using a special low beam mode or dimmed light mode, that takes into consideration the information, e.g., camera, to realize a non-blinding dimmed light pattern, in particular a non-blinding low beam pattern, such as a city light pattern, in the area of a vehicle driving in front, while observing the corresponding legal requirements. To accomplish this, the asymmetric area of the light pattern required for illumination of the edge of the road is preferably displaced far enough to the right/left that this asymmetric area no longer strikes the right/left mirror of the motor vehicle driving in front when driving on the right/left.

Up to now, main light functions distinguish between low beams (including AFS functions as described above) and high beams with ADB. Up to now, in low beam operation, a suitable light pattern is selected through parameters such as vehicle speed, steering angle, ambient light, etc. Up to now the information, e.g., of a camera, has been disregarded, only in ADB high beam operation is a vehicle masked through camera information.

According to the invention, information from at least one object detection system is now also used in low beam operation to reduce or entirely prevent blinding vehicles driving in front through their side view mirrors.

It can be provided that the controller controls the lighting device so that when the dimmed light pattern is activated, in particular when the low beam pattern is activated, the entire dimmed light pattern, in particular the entire low beam pattern, or at least part of this light pattern, is horizontally and/or vertically displaced so that due to the thus modified dimmed light pattern, in particular the thus modified low beam pattern, a lighting device or a motor vehicle for driving on the right/left does not illuminate the right/left side view mirror of a motor vehicle driving in front when the light pattern is activated, and/or controls the lighting device when it is turned on, so that the dimmed light pattern, in particular the low beam pattern, or at least part of it is displaced so that a lighting device or a motor vehicle for driving on the right/left does not illuminate the right/left side view mirror of a motor vehicle driving in front when the light pattern is activated.

Alternatively or additionally, it can be provided, in the case of a lighting device that constructs a light pattern, preferably a dimmed light pattern, in particular a low beam pattern, from individual light segments, e.g., light segments lying horizontally next to one another or next to one another and vertically on top of one another, that the lighting device is controlled by the controller so that when the dimmed light pattern is activated, in particular when the low beam pattern is activated, those light segments that would illuminate a right/left side view mirror of a motor vehicle driving in front when the light pattern is activated, are dimmed or turned off, and/or when a dimmed light pattern, in particular a low beam pattern, is turned on, these light segments are turned on dimmed or are not turned on, so that due to the modified dimmed light pattern, in particular the modified low beam pattern, a lighting device or a motor vehicle for driving on the right/left does not illuminate the right/left side view mirror of a motor vehicle driving in front when the light pattern is activated. It can be advantageous if the controller is set up to control the at least one lighting device continuously, at least starting from the point in time when the dimmed light pattern is turned on, in particular when the low beam pattern is turned on, so that a lighting device or a motor vehicle for driving on the right/left does not illuminate the right/left side view mirror of a motor vehicle driving in front. It is preferably provided that the at least one object detection system observes the surrounding area during the entire time that the dimmed light pattern/low beam pattern is turned on, so that the light pattern can continuously be optimally adapted to changing conditions. It is especially advantageous if the at least one object detection system is already active before the light pattern in question is turned on, so that already when the dimmed light pattern/low beam pattern is turned on, this light pattern can be turned on in the form of a light pattern that has already been modified, if necessary, according to this invention and taking into consideration the traffic driving in front. In particular, it can be advantageous if the controller is set up to control the at least one lighting device to illuminate the maximum possible area of the defined light pattern, in particular of the defined low beam pattern, in particular the entire area of the defined light pattern, in particular of the defined low beam pattern, taking into consideration the information coming from the at least one object detection system. In particular, it can be favorable if a light pattern produced by the lighting device is a dimmed light pattern, in particular a low beam pattern with an asymmetric area in the light/dark boundary of the low beam pattern. For example it can be provided that the lighting device is set up to produce a dimmed light pattern, in particular a low beam pattern, in which the asymmetric area of the light/dark boundary of the low beam pattern runs at an angle of 90° to the horizontal. For example, it is provided that the lighting device is set up to displace the entire dimmed light pattern, in particular the entire low beam pattern, or at least a part of this light pattern, horizontally and/or vertically.

It can be provided that the lighting device is set up to construct at least one light pattern, preferably a dimmed light pattern, in particular a low beam pattern, from individual light segments, e.g., light segments lying horizontally next to one another or next to one another and vertically on top of one another.

It can be provided that the lighting device is in the form of a motor vehicle headlight.

It can also be provided that a motor vehicle headlight comprise one or more such lighting devices. In the latter case, every such lighting device preferably produces a different dimmed light pattern.

It can be expedient if the lighting device system comprises at least one other above-described lighting device, which at least one other lighting device is a right/left motor vehicle headlight or part of a right/left motor vehicle headlight.

It can be favorable if the at least one controller in such a lighting device system also controls the other lighting device, this at least one other lighting device being a right/left motor vehicle headlight or part of a right/left motor vehicle headlight so that a lighting device system for driving on the right/left does not illuminate the right/left side view mirror of a motor vehicle driving in front when a dimmed light pattern is activated, in particular when a low beam pattern is activated, and/or when the dimmed light pattern is turned on, in particular when the low beam pattern is turned on.

In theory, every lighting device (left/right) or every headlight can have its own controller. However, as a rule it is expedient if exactly one controller is provided for all lighting devices.

It is preferably provided that the at least two lighting devices, i.e., the at least one left lighting device and the at least one right lighting device, are synchronously controlled by the at least one controller.

The control of the at least one lighting device or of the at least one motor vehicle headlight or of the lighting device system can be dynamic, i.e., the dimmed light pattern, in particular low beam pattern, is continuously modified according to the information of the at least one optical image recognition system. However, the control can also be static, by not illuminating a certain area of the light pattern in the area illuminated by the unmodified light pattern when a vehicle driving in front is detected. Thus, all that follows is switching between the defined, unmodified light pattern and exactly one modified dimmed light pattern, in particular between two low beam patterns.

The light pattern is typically horizontally swung, e.g., by 1°-3°, preferably about 2°, so the modified low beam pattern is the unmodified low beam pattern displaced by 1°-3°, preferably by about 2°. Or light segments are masked so that the light/dark boundary is displaced to the right or left by a fixed amount, e.g., 1°-3°, preferably about 2°.

Thus, one aspect of this invention is to displace the asymmetric area in the light/dark boundary of a low beam pattern, i.e., a dimmed light pattern that has such an asymmetric area, so that no blinding of the passengers occurs, in particular no blinding of the driver of a vehicle driving in front, in particular of a passenger vehicle or a motorcycle, or so that such blinding is reduced.

The invention is discussed in detail below using the drawing. The figures are as follows:

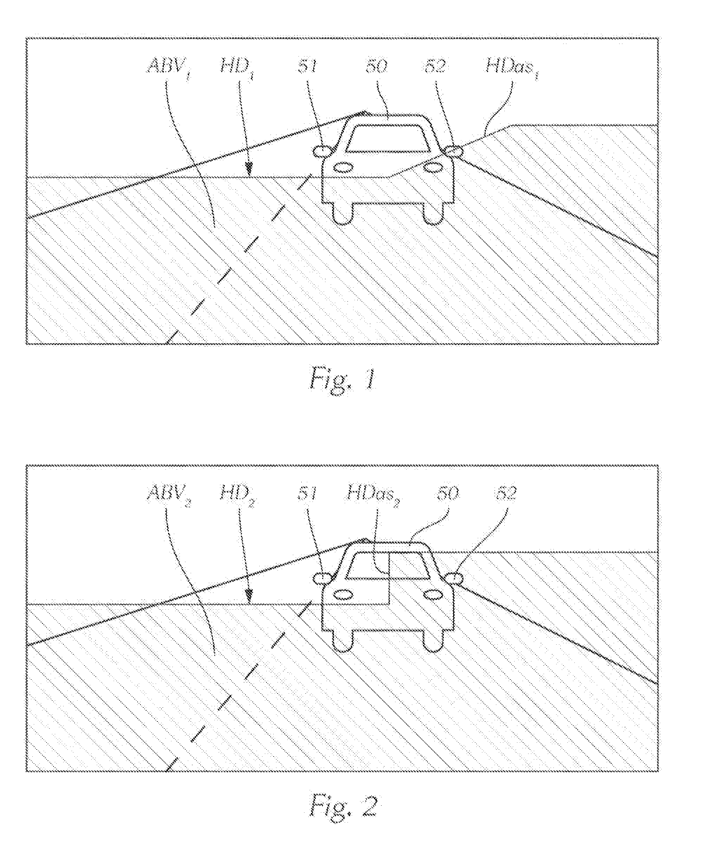

FIG. 1 is a situation for driving on the right with a motor vehicle driving in front and a low beam pattern;

FIG. 2 is a situation for driving on the right with a motor vehicle driving in front and a low beam pattern with a 90° asymmetry;

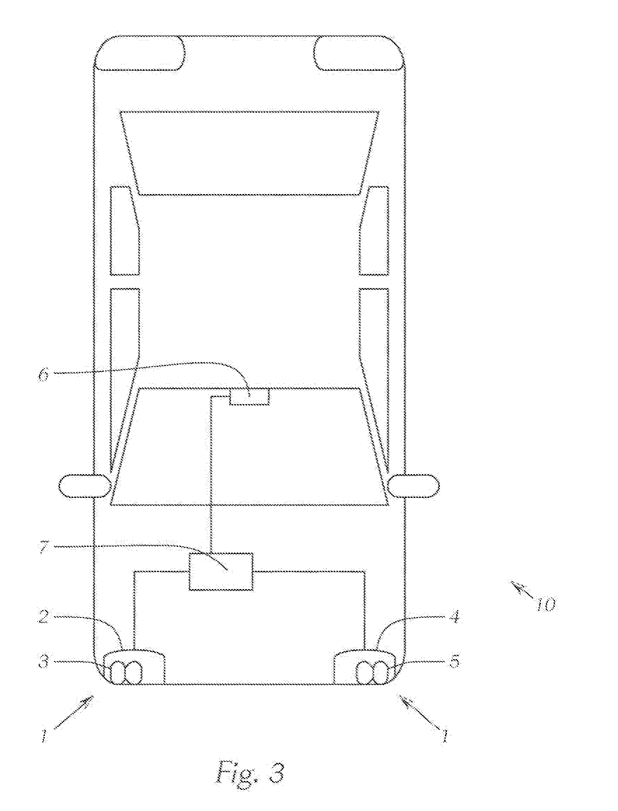

FIG. 3 is a schematic view of an inventive motor vehicle with two motor vehicle headlights;

FIG. 4 is the situation from FIG. 1 with an inventively modified low beam pattern; and

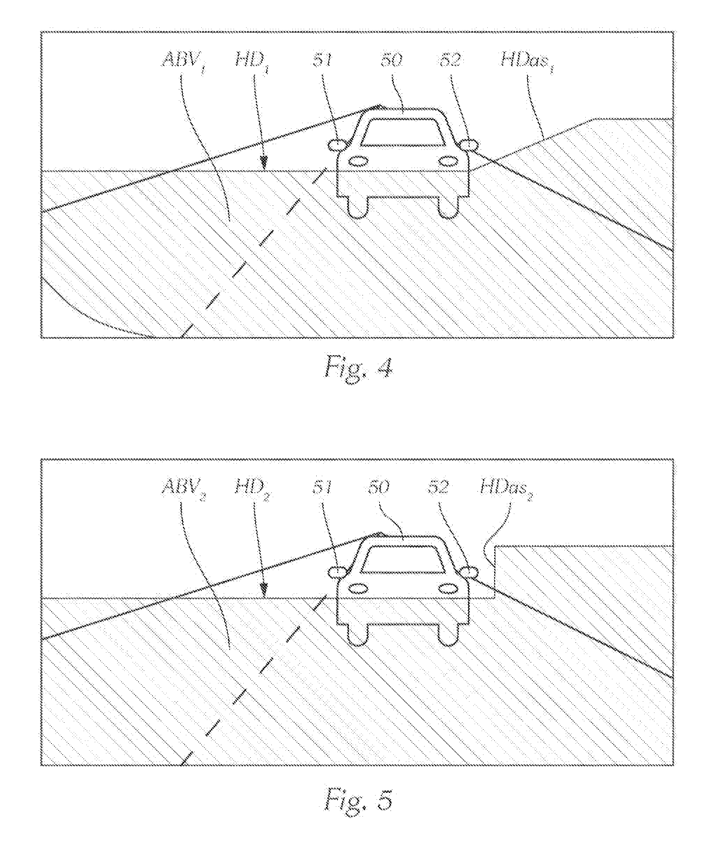

FIG. 5 is the situation from FIG. 2 with an inventively modified low beam pattern.

FIG. 1 shows the view from a motor vehicle looking forward onto the road. This figure represents the situation for driving on the right. The motor vehicle (not shown) located on the right side of the road has a motor vehicle 50 located in front of it, in particular an at least two-track passenger vehicle. This passenger vehicle 50, which is thus seen from behind, has a left side view mirror 51 and a right side view mirror 52.

The motor vehicle from which the forward view is shown has a lighting device system which comprises two motor vehicle headlights, a left headlight and a right headlight, and which produces a low beam pattern ABV1 in the illustration shown.

The low beam pattern ABV1 has a light/dark boundary HD1, which has an asymmetric section HDas1 that rises at an angle of about 45° to the horizontal, in a way known in the art.

As can be seen, the right side view mirror 52 of the passenger vehicle driving in front can be illuminated under some circumstances, in particular due to the asymmetric area of the low beam pattern ABV1, which can lead to blinding of the passengers, in particular the driver, of the passenger vehicle 50 driving in front.

FIG. 2 shows a situation similar to that in FIG. 1, with the difference that here the low beam pattern ABV2 has an asymmetric section HDas2 in the light/dark boundary HD2 that rises at an angle of 90°.

As can clearly be seen, the risk of illuminating the right side view mirror 52 of the motor vehicle, in particular the passenger vehicle, driving in front, presented by such low beam patterns is even clearly greater than is the case in the situation shown in FIG. 1.

FIG. 3 shows an example of an inventive motor vehicle 10, which can reduce or entirely prevent the described blinding.

The vehicle 10 has a lighting device system 1, which consists of a right and a left headlight 2, 4. Each headlight 2, 4 comprises at least one lighting device 3, 4, which is set up to produce a low beam pattern as described on the basis of FIG. 1 or FIG. 2.

Furthermore, a controller 7 is provided to control the two lighting devices 3, 5 or generally speaking the two headlights 2, 4.

In addition, an object detection system, preferably an optical image recognition system 6, typically a camera, is also provided, which monitors the area lying in front of the motor vehicle 10 (see FIGS. 1 and 2).

The controller 7 receives information from the camera 6, in particular, what the camera 6 “detects” in front of the vehicle 10, and the controller can correspondingly control the lighting devices 2, 4 on the basis of this information.

Now if the camera 6 detects a motor vehicle 50 driving in front, and if the right side view mirror 52 of this vehicle 50 would be illuminated by the defined low beam pattern ABV1, ABV2, as shown in FIG. 1 or FIG. 2, the controller 7 can control at least one of the two lighting devices 2, 4, preferably both of them, to produce a modified low beam pattern ABV1′, ABV2′ that does not illuminate the right side view mirror 52.

Such non-blinding, modified low beam patterns are shown in FIG. 4 and FIG. 5, FIG. 4 showing a modification of the low beam pattern ABV1 from FIG. 1 and FIG. 5 showing a modification of the low beam pattern ABV2 from FIG. 2.

Preferably, the camera 6 observes the surrounding area continuously, or is turned on when the low beam pattern is turned on, so that the light pattern can always be optimally adjusted according to the invention—both while it is being turned on and when it has been turned on and is in operation.

It can be sufficient if only one of the two headlights or one of the two the lighting devices is controlled according to the invention. When driving on the right, typically the left headlight or the lighting device 5 arranged in the left headlight is the more critical one, so that at least this one is controlled according to the invention.

However, preferably both lighting devices 3, 5 or headlights 2, 4 are controlled according to the invention. Each lighting device/headlight can have its own controller, however preferably both lighting devices 3, 5 or headlights 2, 4 are controlled by a common controller 7, which receives information from the camera 6.

It is preferably provided that the defined light pattern is modified exactly enough that exactly no blinding occurs, or that the blinding is sufficiently reduced, depending on the situation that is detected using the camera 6. Thus, there are multiple different modified light patterns, depending on the situation in front of the motor vehicle.

FIG. 1 shows, e.g., the unmodified, defined low beam pattern ABV1. According to the invention, this pattern is horizontally swung to the right to produce the modified low beam pattern ABV1′ according to FIG. 4. The shape of the low beam pattern has not substantially changed, and is only possibly slightly distorted, but has essentially only changed its position in front of the motor vehicle (see the position of the asymmetry HDas1 and the position of the left lower area of the light patterns ABV1, ABV1′).

Such a displacement of the low beam pattern or generally of a (dimmed) light pattern can easily be implemented, e.g., using a lighting device that is set up to realize a curve light.

Such a lighting device can be, e.g., a projection system, for instance a module, in particular a projection module comprising a reflector and/or a lens, light source, and possibly means to produce a light/dark boundary, e.g., a shading element. To realize the curve light, the entire module/projection module can be horizontally swung about a vertical axis, or only parts of it (in particular a reflector or lens) can be horizontally swung about such an axis, which can horizontally swing the light pattern that is produced to the left or right.

This invention can use this for its own purposes by making such horizontal swinging of the module (or parts of it) stronger or weaker depending on the position of a vehicle driving in front, in particular the position of its right side view mirror, if necessary even when driving straight forward, or when traveling through a curve.

For example, FIG. 4 shows horizontal swinging of the low beam pattern ABV1 from FIG. 1 by about 2° to the right, producing the low beam pattern ABV1′.

Such horizontal swinging of the light pattern also correspondingly horizontally swings the maximum of the light pattern.

FIG. 2 shows, e.g., the unmodified, defined low beam pattern ABV2. This low beam pattern ABV2 is constructed, for example, from individual light segments, e.g., light segments lying horizontally next to one another or next to one another and vertically on top of one another. Every light segment is controllable independently of the others, e.g., by producing every light segment using its own light source, for instance its own LED, and the individual light sources being controllable independently of one another, in particular being capable of being turned on and off independently of one another.

In particular, such a segmented light pattern allows a low beam pattern ABV2 to be produced with a 90° asymmetry HDas2 of the light/dark boundary HD2.

Inventive modification of this low beam pattern ABV2 involves now turning off those light segments that would illuminate the right side view mirror 52 of the vehicle driving in front 50, to produce the low beam pattern ABV2′ shown in FIG. 5. This low beam pattern ABV2′ differs from the unmodified, defined low beam pattern ABV2 only in that the asymmetric area HDas2′ of the light/dark boundary HD2′ now lies farther to the right, so that the side view mirror 52 is not illuminated. In other respects, the low beam pattern is unchanged, and the maximum here remains in the middle of the road.

The figures have described the situation for countries with right-hand drive. For left-hand drive, the opposite directions apply.

1. A controller (7) for controlling at least one lighting device (3, 5) for a motor vehicle (10) or for controlling a motor vehicle headlight (2, 4) that has at least one such lighting device (3, 5), this at least one lighting device (3, 5) being set up at least to produce at least one defined low beam pattern (ABV1, ABV2), in an area in front of the lighting device (3, 5), in particular in an area in front of the motor vehicle (10),
wherein the at least one lighting device (3, 5) is set up so that at least one defined low beam pattern (ABV1, ABV2) with an asymmetric area (HDas1, HDas2) in the light/dark boundary (HD1, HD2) of the low beam pattern, this asymmetric area (HDas1, HDas2) being provided for selective illumination of the right or left edge of the road,
is modified within the limits of legal requirements, at least with respect to its position and/or shape, when a low beam pattern is turned on, and/or
the low beam pattern whose position and/or shape has been modified within the limits of legal requirements is turned on,
wherein the controller (7) is configured to use information that comes from at least one object detection system (6), e.g., an optical image recognition system,
wherein the at least one object detection system (6) is configured to monitor the area lying in front of the lighting device (3, 5) or the motor vehicle (10), in particular at least the area illuminated by the at least one low beam pattern, and to detect at least one vehicle, in particular a passenger vehicle, driving in front of the vehicle in which the object detection system is arranged, it being possible to determine the position and/or distance of the vehicle driving in front with respect to the object detection system, and also one or both side view mirrors of the vehicle driving in front, and
wherein the object detection system is configured to control the at least one lighting device so that if the driver of a vehicle driving in front is blinded through one or both side view mirrors, the asymmetric area (HDas1, HDas2) of the lighting device or a motor vehicle for driving on the right or left is displaced far enough horizontally that this asymmetric area (HDas1, HDas2) no longer strikes the right or left side view mirror (52) of a motor vehicle (50) driving in front when the low beam pattern (ABV1′, ABV2′) is activated, and/or when the low beam pattern (ABV1′, ABV2′) is turned on.

2. (canceled)

3. The controller according to claim 1, wherein, in the case of a lighting device that constructs a light pattern, in particular a low beam pattern (ABV2), from individual light segments, e.g., light segments lying horizontally next to one another or next to one another and vertically on top of one another, the lighting device is controlled by the controller so that when the low beam pattern is activated, those light segments that would illuminate a right or left side view mirror of a motor vehicle driving in front when the light pattern is activated, are dimmed or turned off, and/or when a low beam pattern, is turned on, these light segments are turned on dimmed or are not turned on, so that due to the modified low beam pattern (ABV2′), a lighting device or a motor vehicle for driving on the right or left does not illuminate the right or left side view mirror (52) of a motor vehicle (50) driving in front when the light pattern is activated.

4. The controller of claim 1, which is set up to control the at least one lighting device continuously, at least starting from the point in time when the low beam pattern is turned on, so that a lighting device or a motor vehicle for driving on the right or left does not illuminate the right or left side view mirror (52) of a motor vehicle (50) driving in front.

5. The controller of claim 1, which is set up to control the at least one lighting device to illuminate the maximum possible area of the defined low beam pattern (ABV1, ABV2), in particular the entire area of the defined low beam pattern (ABV1, ABV2), taking into consideration the information coming from the at least one object detection system.

6. A motor vehicle lighting device, this at least one lighting device being set up at least to produce at least one defined low beam pattern, in an area in front of the lighting device, in particular in an area in front of the motor vehicle,
wherein the lighting device comprises a controller according to claim 1,
wherein the at least one lighting device (3, 5) is set up so that at least one defined low beam pattern (ABV1, ABV2) with an asymmetric area (HDas1, HDas2) in the light/dark boundary (HD1, HD2) of the low beam pattern, this asymmetric area (HDas1, HDas2) being provided for selective illumination of the right or left edge of the road
is modified within the limits of legal requirements, at least with respect to its position and/or shape, when a low beam pattern is turned on, and/or
the low beam pattern whose position and/or shape has been modified within the limits of legal requirements is turned on,
wherein the lighting device comprises at least one object detection system (6), e.g., an optical image recognition system,
wherein the controller is configured to use information that comes from the at least one object detection system,
wherein the at least one object detection system is configured to monitor the area lying in front of the lighting device or the motor vehicle, in particular the area illuminated by the at least one low beam pattern, and to detect at least one vehicle, in particular a passenger vehicle, driving in front of the vehicle in which the object detection system is arranged, it being possible to determine the position and/or distance of the vehicle driving in front with respect to the object detection system, and also one or both side view mirrors of the vehicle driving in front, and
wherein the object detection system is configured to control the at least one lighting device so that if the driver of a vehicle driving in front is blinded through one or both side view mirrors, the asymmetric area (HDas1, HDas2) of the lighting device or a motor vehicle for driving on the right or left is displaced far enough horizontally that this asymmetric area (HDas1, HDas2) no longer strikes the right or left side view mirror of a motor vehicle (50) driving in front when the low beam pattern (ABV1′, ABV2′) is activated, and/or when the low beam pattern (ABV1′, ABV2′) is turned on.

7. The lighting device of claim 6, wherein the asymmetric area (HDas2) of the light/dark boundary (HD2) of the low beam pattern (ABV2) runs at an angle of 90° to the horizontal.

8. The lighting device of claim 6, which is set up to displace the entire low beam pattern (ABV1), or at least a part of this light pattern, horizontally and/or vertically.

9. The lighting device of claim 6, which is set up to construct at least one low beam pattern (ABV2), from individual light segments, e.g., light segments lying horizontally next to one another or next to one another and vertically on top of one another.

10. The lighting device of claim 6, which is in the form of a motor vehicle headlight.

11. A motor vehicle headlight that comprises one or more of the lighting devices of claim 6.

12. A lighting device system (1) for a motor vehicle (10), this lighting device system (1) comprising:
two motor vehicle headlights (2, 4), a left and a right motor vehicle headlight, and being provided for a motor vehicle for driving on the right or left, wherein the two motor vehicle headlights are configured to produce at least one low beam pattern (ABV1, ABV2, ABV1′, ABV2′);
at least one lighting device (3, 5) to which is the left or right motor vehicle headlight or part of the left or right motor vehicle headlight (2, 4);
at least one controller (7) according to claim 1; and
at least one object detection system (6), e.g., an optical image recognition system,
wherein the controller is set up to use information that comes from the at least one object detection system (6), the at least one object detection system monitoring the area lying in front of the lighting device or the motor vehicle (10), in particular at least the area illuminated by the at least one low beam pattern, and being set up to detect at least one vehicle, in particular a passenger vehicle, driving in front of the vehicle in which the object detection system is arranged, it being possible to determine the position and/or distance of the vehicle driving in front with respect to the object detection system, and also one or both side view mirrors of the vehicle driving in front, and
wherein the object detection system is configured to control the at least one lighting device so that if the driver of a vehicle driving in front is blinded through one or both side view mirrors, the asymmetric area (HDas1, HDas2) of the lighting device system for driving on the right or left is displaced far enough horizontally within the limits of legal requirements that this asymmetric area (HDas1, HDas2) no longer strikes the right or left side view mirror (52) of a motor vehicle (50) driving in front when a low beam pattern (ABV1′, ABV2′) is activated, and/or when the low beam pattern is turned on.

13. The lighting device system of claim 12, further comprising at least one other lighting device, which at least one other lighting device is the other of the right or left motor vehicle headlight or part of the other of the right or left motor vehicle headlight.

14. The lighting device system of claim 13, wherein the at least one controller is configured to also control the other lighting device so that a lighting device system for driving on the right or left displaces the asymmetric area (HDas1, HDas2) far enough horizontally that this asymmetric area (HDas1, HDas2) no longer strikes the right or left side view mirror of a motor vehicle driving in front when a low beam pattern is activated, and/or when the low beam pattern is turned on.

15. The lighting device system of claim 14, wherein the at least two lighting devices, i.e., the at least one left lighting device and the at least one right lighting device, are synchronously controlled by the at least one controller.

16. A motor vehicle (1) comprising two motor vehicle headlights (3, 4), each of said motor vehicle headlights comprising at least one lighting device of claim 6.

17. A process for controlling at least one lighting device (3, 5) according to claim 6, comprising the steps:
monitoring an area lying in front of the at least one lighting device (3, 5) or the motor vehicle, in particular at least the area illuminated by the at least one low beam pattern (ABV1, ABV2), using at least one object detection system (6), e.g., an optical image recognition system, the object detection system being set up to detect at least one vehicle, in particular a passenger vehicle, driving in front of the vehicle in which the object detection system is arranged, it being possible to determine the position and/or distance of the vehicle driving in front with respect to the object detection system, and also one or both side view mirrors of the vehicle driving in front; and
controlling, by at least one controller (7), the at least one lighting device using information that comes from the at least one object detection system (6) in such a way that a defined low beam pattern (ABV1, ABV2) with an asymmetric area (HDas1, HDas2) in the light/dark boundary (HD1, HD2) of the low beam pattern, this asymmetric area (HDas1, HDas2) being provided for selective illumination of the right or left edge of the road,
is modified within the limits of legal requirements, at least with respect to its position and/or shape, when a low beam pattern is turned on, and/or
the low beam pattern whose position and/or shape has been modified
within the limits of legal requirements is turned on, so that if the driver of a vehicle driving in front is blinded through one or both side view mirrors, the asymmetric area (HDas1, HDas2) of the lighting device or a motor vehicle for driving on the right or left is displaced far enough horizontally that this asymmetric area (HDas1, HDas2) no longer strikes the right or left side view mirror (52) of a motor vehicle (50) driving in front when a low beam pattern (ABV1′, ABV2′) is activated, and/or when the dimmed light pattern is turned on, in particular when the low beam pattern (ABV1′, ABV2′) is turned on.
